(19) United States
(12) Patent Application Publication
(10) Pub. No.: US 2019/0362188 A1
(43) Pub. Date: Nov. 28, 2019

(54) INFORMATION PROCESSING METHOD, INFORMATION PROCESSING APPARATUS, AND PROGRAM

(71) Applicant: JTEKT CORPORATION, Osaka (JP)

(72) Inventor: Akiyoshi NAKASE, Kashiba-shi (JP)

(73) Assignee: JTEKT CORPORATION, Osaka (JP)

(21) Appl. No.: 16/413,699

(22) Filed: May 16, 2019

(30) Foreign Application Priority Data
May 22, 2018 (JP) 2018-098169

(51) Int. Cl. G06K 9/62; G06N 20/20

(52) U.S. Cl. CPC G06K 9/6257; G06K 9/6218; G06K 9/6231; G06N 20/20

(57) ABSTRACT

An information processing method includes: generating a first learning model by conducting machine learning using, as teacher data, a predetermined number of pieces of non-defective product data extracted from product data; determining, for each of a plurality of pieces of product data to be determined after the first learning model is generated, whether each product is non-defective or defective in accordance with the first learning model; grouping the pieces of product data determined to be defective, such that these pieces of product data are classified according to defect type; collectively associating type labels indicative of defect types with the defective product data according to defect type group; and generating a second learning model by conducting machine learning using, as teacher data, the defective product data with which the type labels are associated and the non-defective product data.

### INCORPORATION BY REFERENCE

The disclosure of Japanese Patent Application No. 2018-098169 filed on May 22, 2018, including the specification, drawings and abstract, is incorporated herein by reference in its entirety.

### BACKGROUND OF THE INVENTION

### 1. Field of the Invention

The invention relates to information processing methods, information processing apparatuses, and programs.

### 2. Description of the Related Art

Making determinations and/or classifications using computer-based machine learning usually requires huge data for machine learning. Such data needs teacher labels each serving as an annotation for each of these pieces of data. For example, making a visual inspection of products using a computer requires huge product data (e.g., external image data) for the products to be inspected, and teacher labels, such as non-defective product labels and defective product labels for the products. When products are to be classified into two categories (i.e., non-defective products and defective products), a visual inspection of the products preferably involves generating a learning model by causing a computer to conduct machine learning on product data having, for example, non-defective product teacher labels (i.e., non-defective product labels) assigned thereto. Japanese Patent Application Publication No. 2017-102865 (JP 2017-102865 A) discloses a technique for carrying out such information processing using a computer.

Defective products may be further classified according to defect type. Such classification, however, makes it necessary to attach a teacher label, such as a type label indicative of a defect type, to each piece of huge product data in conducting machine learning. Attaching identification labels to all pieces of huge product data requires an enormous number of man-hours and proves to be impractical. When operators attach identification labels to, in particular, huge product data, the results of type determinations may vary or determination error may occur depending on the operators. Accordingly, the technique known in the related art has difficulty in generating a learning model that makes it possible to determine the types of defective products.

### SUMMARY OF THE INVENTION

An object of the invention is to facilitate generation of a learning model that makes it possible to determine the types of defective products in addition to determining whether each product is non-defective or defective.

An information processing method according to an aspect of the invention includes a first generating step, a first determining step, a classifying step, a labeling step, and a second generating step. The first generating step involves generating a first learning model by conducting machine learning using, as teacher data, at least either a predetermined number of pieces of non-defective product data or a predetermined number of pieces of defective product data extracted from product data. The first determining step involves determining, for each of a plurality of pieces of product data to be determined after the first learning model is generated, whether each product is non-defective or defective in accordance with the first learning model. The classifying step involves grouping the pieces of product data determined to be defective in the first determining step, such that these pieces of product data are classified according to defect type. The labeling step involves collectively associating type labels indicative of defect types with the defective product data according to defect type group provided in the classifying step. The second generating step involves generating a second learning model by conducting machine learning using, as teacher data, the defective product data with which the type labels are associated and the non-defective product data.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a block diagram schematically illustrating an exemplary hardware configuration of an information processing apparatus;

FIG. 2 is a conceptual diagram illustrating information processing to be carried out by the information processing apparatus; and

FIG. 3 is a diagram illustrating a software configuration of the information processing apparatus.

### DETAILED DESCRIPTION OF EMBODIMENTS

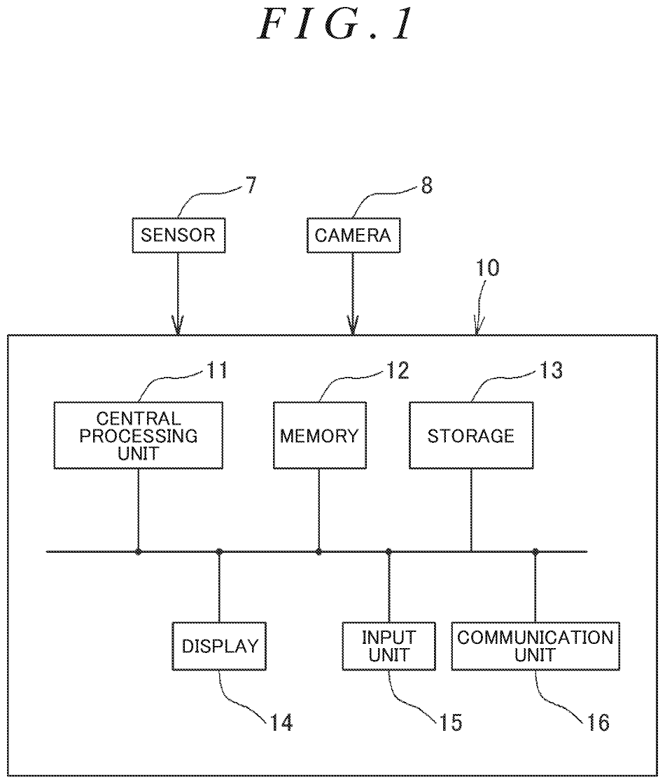

FIG. 1 is a block diagram schematically illustrating an exemplary hardware configuration of an information processing apparatus 10 according to an embodiment of the invention. The information processing apparatus 10 according to the present embodiment is used in an inspection step of a production line for products. Examples of the products include not only a component such as a bearing ring for a rolling bearing but also an assembly made up of a plurality of components. Examples of such an assembly include a steering system (such as an electric power steering system) and a rolling bearing.

When the products are assemblies, the inspection step involves operating (or rotating) each product and measuring vibrations (or sounds) of each product using a sensor 7 brought into contact with a portion of the product. The information processing apparatus 10 receives data resulting from the measurements made by the sensor 7 in the form of product data. Irrespective of whether the products are components or assemblies, the inspection step may involve capturing an image of each product with a camera 8 so as to conduct a visual inspection. In this case, the information processing apparatus 10 receives data of images captured with the camera 8 in the form of product data. Product data may thus be vibration data or image data (e.g., external image data). Alternatively, product data may be processed data provided by processing vibration data (which is raw data) obtained using the sensor 7 or processed data provided by processing image data (which is raw data) obtained using the camera 8. Examples of such processed data include frequency data generated by conducting an analysis (e.g., a Fourier analysis) on vibration data that is time series data obtained using the sensor 7. Alternatively, the processed data may be image analysis data obtained by conducting an image analysis on data of captured images. The use of vibration data enables the information processing apparatus 10 to conduct an operational inspection on the products. The use of image data enables the information processing apparatus 10 to conduct a visual inspection on the products.

The information processing apparatus 10 determines whether each product produced in the production line is non-defective or defective. The information processing apparatus 10 has the function of determining the defect type (or category) of each defective product. The following description is based on the assumption that the products are steering systems, and vibration data is used as product data. Examples of defect types in this case include a defect in a specific gear portion and a defect in a specific bearing portion. Operating steering systems having such defects induces vibrations having different frequency components. Because the frequency components have characteristics, the information processing apparatus 10 is able to determine the defect types on the basis of the characteristics of the frequency components. When image data is used as product data, shades resulting from flaws, for example, are converted into data, and the information processing apparatus 10 is able to determine the defect types on the basis of this data.

The configuration of the information processing apparatus 10 will be described. The information processing apparatus 10 includes a central processing unit (CPU) 11, a memory 12, a storage 13, a display 14, an input unit 15, and a communication unit 16. The memory 12 includes a read-only memory (ROM) and a random-access memory (RAM). The storage 13 includes a hard disk drive. The CPU 11 reads a program (e.g., a computer program) stored in the memory 12 or the storage 13 so as to execute various processes. The storage 13 stores various pieces of information, such as data received from the sensor 7, data (i.e., product data) obtained by processing the data received from the sensor 7, learning models (which will be described below), and the program. The information processing apparatus 10 includes various functional units (which will be described below). The CPU 11 reads the program stored in the memory 12 or the storage 13 and executes the program so as to cause each functional unit to perform its function.

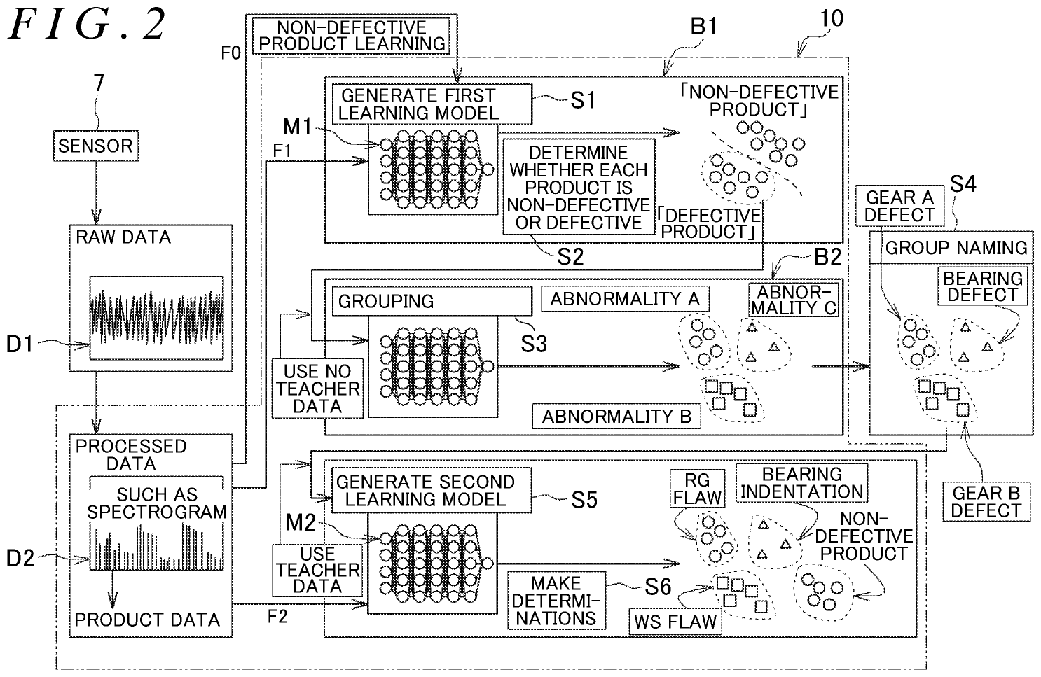

Information processing carried out by the information processing apparatus 10 enables an inspection of the products (e.g., steering systems). An inspection of the products (i.e., an inspection step) is included in the production line to produce the products. FIG. 2 is a conceptual diagram illustrating information processing (i.e., an inspection) to be carried out by the information processing apparatus 10. The information processing apparatus 10 conducts a frequency analysis on vibration data (or raw data) D1 obtained by the sensor 7. The information processing apparatus 10 uses processed data D2 (such as a spectrogram obtained as a result of the frequency analysis) as “product data”. The information processing apparatus 10 is used from the start-up of the production line. The number of pieces of product data is small in an initial stage of the start-up of the production line (i.e., an initial stage of the start of information processing carried out by the information processing apparatus 10). The number of pieces of product data increases as the production of the products in the production line progresses.

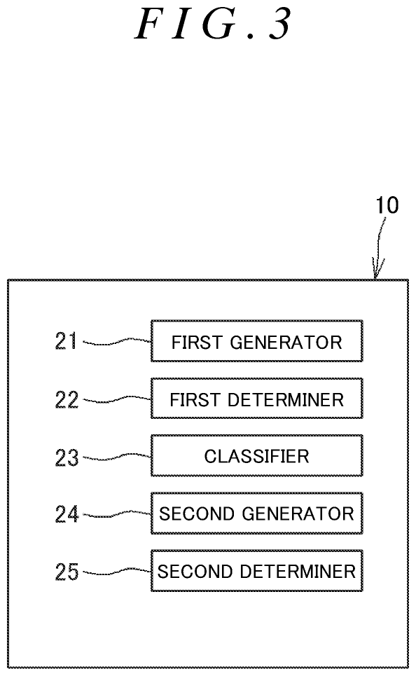

FIG. 3 is a diagram illustrating a software configuration of the information processing apparatus 10. The functional units of the information processing apparatus 10 include a first generator 21, a first determiner 22, a classifier 23, a second generator 24, and a second determiner 25. As previously mentioned, the CPU 11 executes the program so as to cause each of these functional units to perform its function. Specifically, the program causes a computer to function as the first generator 21, the first determiner 22, the classifier 23, the second generator 24, and the second determiner 25. The program may be stored in any of various storage media.

As previously described, the number of pieces of product data is small in the initial stage of the start-up of the production line (i.e., the initial stage of the start of information processing). Accordingly, a predetermined number of pieces of product data obtained for non-defective products are extracted from a small number of pieces of product data obtained in the initial stage of the start-up of the production line. Product data obtained for non-defective products will hereinafter be referred to as “non-defective product data”. Information on “non-defective product labels” each provided in the form of a teacher label is associated with (or attached to) the non-defective product data extracted. An operator extracts the non-defective product data and creates associations between the non-defective product data and the information on “non-defective product labels”. Product data obtained for defective products will hereinafter be referred to as “defective product data”.

The first generator 21 performs the process of generating a first learning model M1 by conducting machine learning using the extracted non-defective product data as teacher data. This process is performed in a first generating step S1 in FIG. 2. Examples of machine learning conducted in this step include deep learning. The production line that actually produces the products has difficulty in collecting defective product data in the initial stage of the start-up of the production line (i.e., the initial stage of the start of information processing). Non-defective product data, however, is collectable more easily than defective product data. In the present embodiment, machine learning conducted by the first generator 21 is “non-defective product learning” that involves using non-defective product data as teacher data. The non-defective product data is data obtained in the initial stage of the start of information processing. As indicated by the arrow F0 in FIG. 2, the first generator 21 performs the process of acquiring the non-defective product data to be used for non-defective product learning. When the number of pieces of defective product data collected is large in the initial stage of the start of information processing, the first generator 21 may conduct machine learning using the defective product data as teacher data. Alternatively, non-defective product data and defective product data may be used as teacher data. As described above, the first generator 21 has the function of generating the first learning model M1 by conducting machine learning using, as teacher data, a predetermined number of pieces of non-defective product data (or at least either a predetermined number of pieces of non-defective product data or a predetermined number of pieces of defective product data) extracted by the operator from a small number of pieces of product data obtained in the initial stage of the start-up of the production line. The first learning model M1 generated by the first generator 21 is a learning model to be used to determine whether each product is non-defective or defective.

The first determiner 22 performs the process of determining, for each of a plurality of pieces of product data, whether each product is non-defective or defective in accordance with the first learning model M1 generated by the first generator 21. This process is performed in a first determining step S2 in FIG. 2. Examples of a model for making such determinations include a variational auto-encoder (VAE). The product data to be determined includes a plurality of pieces of product data obtained after the first learning model M1 is generated. In other words, the product data to be determined is data obtained in an intermediate stage that comes after the initial stage of the start of information processing. In the intermediate stage of information processing, the production of the products in the production line is in progress, so that the number of pieces of defective product data in the intermediate stage is larger than the number of pieces of defective product data in the initial stage. The first determiner 22 thus performs the determining process when a predetermined number of pieces of defective product data have presumably been collected. The first determiner 22 performs the determining process so as to determine whether product data on each actual product is non-defective product data or defective product data. As indicated by the arrow F1 in FIG. 2, the first determiner 22 performs the process of acquiring the product data to be determined. As illustrated in the right portion of a first block B1 in FIG. 2, the first determiner 22 classifies each product (or each piece of product data) as “non-defective” or “defective”.

In the present embodiment, the products to be inspected are steering systems. Operating the steering systems induces vibrations having different frequency components responsive to defect types. Each frequency component has a characteristic for each defect type. The information processing apparatus 10 is thus able to determine defect types in accordance with the characteristics so as to group product data. The classifier 23 performs this grouping process.

The classifier 23 performs the process of grouping a plurality of pieces of product data (i.e., defective product data) determined to be defective by the first determiner 22, such that these pieces of product data are classified according to defect type. This process is performed in a classifying step S3 in FIG. 2. The grouping process performed in this step uses no teacher data and involves conducting a cluster analysis (i.e., clustering). Examples of a clustering algorithm to be used include k-means clustering. The pieces of product data determined to be defective are thus classified according to defect type. Such a classifying process (or grouping process) is performed by a computer. This makes it impossible to identify what specific kind of defect each defect type indicates. To solve this problem, the classifier 23 divides defective product data into a plurality of groups as illustrated in the right portion of a second block B2 in FIG. 2. In the example illustrated in FIG. 2, defective product data is divided into the following three groups: an “abnormality A”, an “abnormality B”, and an “abnormality C”. Because defective product data is usually divided into three or more groups, the number of groups may be three or more.

Examples of defect types for steering systems include a defect such as a flaw in a gear A (which will hereinafter be referred to as a “gear A defect”), a defect such as a flaw in a gear B (which will hereinafter be referred to as a “gear B defect”), and a defect such as an indentation in a bearing (which will hereinafter be referred to as a “bearing defect”). The groups “abnormality A”, “abnormality B”, and “abnormality C” are each associated with one of the “gear A defect”, the “gear B defect”, and the “bearing defect”, and defect identification labels are assigned thereto. In the present embodiment, the “abnormality A” is associated with the “gear A defect”, the “abnormality B” is associated with the “gear B defect”, and the “abnormality C” is associated with the “bearing defect”. A labeling step S4 in FIG. 2 thus involves creating such associations (i.e., assigning defect identification labels). The process of creating such associations will hereinafter be referred to as “group naming”. The process of creating such associations (i.e., group naming) is performed by the operator. Creating such associations involves extracting some of the grouped products (or product data) so as to use the extracted products (or product data) as samples. One example involves visually inspecting the extracted products (or analyzing the extracted product data) so as to check the presence of any defect, such as a flaw, recognizing the defect type for each of these products, and collectively naming each group including the products having the same defect type. In other words, a defect identification label is collectively associated with each group including the products having the same defect type.

Type labels indicative of the defect types are thus collectively associated with the defective product data according to defect type group provided by the classifier 23. Specifically, the labeling step S4 involves collectively assigning the same type label to all of a plurality of pieces of defective product data included in each classified group instead of assigning a defect type label to the classified defective product data piece by piece.

The second generator 24 has the function of generating a second learning model M2 (see FIG. 2). The process of generating the second learning model M2 is performed in a second generating step S5 in FIG. 2. The second generator 24 generates the second learning model M2 by conducting machine learning using, as teacher data, the defective product data, with which the type labels are collectively associated as previously described, and the non-defective product data. Examples of machine learning conducted in this step include deep learning. The non-defective product data used in machine learning in this step includes at least either the non-defective product data used for non-defective product learning in the first generating step S1 or the product data determined to be non-defective product data by the first determiner 22 in the first determining step S2. In the present embodiment, the non-defective product data used in the first generating step S1 and the product data determined to be non-defective product data in the first determining step S2 are both used in the second generating step S5. The product data used in machine learning in the second generating step S5 includes, in addition to the non-defective product data, the defective product data (or product data) with which the identification labels indicative of the defect types are associated. In other words, the second generator 24 conducts machine learning using, as teacher data, the non-defective product data to which the non-defective product labels are assigned and the defective product data to which the identification labels indicative of the defect types are assigned. The first learning model M1 that has already been generated is a learning model that makes it possible to determine whether each product is non-defective or defective. The second learning model M2 is a learning model that makes it possible to determine, when any of the products is defective, the defect type for the defective product, in addition to determining whether each product is non-defective or defective.

After the second generator 24 has generated the second learning model M2, the learning model to be used by the information processing apparatus 10 changes from the first learning model M1 to the second learning model M2.

The second determiner 25 has the function of determining, for each of a plurality of pieces of product data, whether each product is non-defective or defective and determining the defect type for each defective product in accordance with the second learning model M2 generated by the second generator 24. This determining process is performed in a second determining step S6 in FIG. 2. Examples of a model for making such determinations include a variational auto-encoder (VAE). The product data to be determined is product data on the products that is obtained after the second learning model M2 is generated. In other words, the product data to be determined includes a plurality of pieces of product data obtained after an intermediate stage that comes after the start of information processing. After the intermediate stage of information processing, the production of the products in the production line is in progress, so that the number of pieces of product data further increases. As indicated by the arrow F2 in FIG. 2, the second determiner 25 performs the process of acquiring the product data to be determined. The use of the second learning model M2 would make it possible not only to determine whether each product is non-defective or defective but also to determine the defect type for each defective product even if the number of pieces of product data is large.

Referring to FIG. 2, an information processing method to be performed by the information processing apparatus 10 configured as described above will be described below. The information processing method includes the first generating step S1 involving generating the first learning model M1, the first determining step S2, the classifying step S3, the labeling step S4, the second generating step S5, and the second determining step S6. The first generating step S1 is performed by the first generator 21 (see FIG. 3). The first determining step S2 is performed by the first determiner 22 (see FIG. 3). The classifying step S3 is performed by the classifier 23 (see FIG. 3). Although the labeling step S4 may be performed by a computer similarly to the other steps, the labeling step S4 is performed by the operator in the present embodiment. The second generating step S5 is performed by the second generator 24 (see FIG. 3). The second determining step S6 is performed by the second determiner 25 (see FIG. 3).

The first generating step S1 involves generating the first learning model M1 by conducting machine learning using, as teacher data, a predetermined number of pieces of non-defective product data extracted from a small number of pieces of product data obtained in the initial stage of the start-up of the production line. The first determining step S2 involves determining, for each of a plurality of pieces of product data to be determined after the first learning model M1 is generated, whether each product is non-defective or defective in accordance with the first learning model M1. When the number of pieces of product data determined to be defective product data in the first determining step S2 has reached a certain level, the classifying step S3 involves grouping the pieces of product data (or defective product data) such that these pieces of product data are classified according to defect type. This grouping process involves classifying the product data having similar characteristics into the same group without using any teacher data. The labeling step S4 involves collectively associating the type labels indicative of the defect types with the defective product data according to defect type group provided in the classifying step S3. The second generating step S5 involves generating the second learning model M2 by conducting machine learning using, as teacher data, the defective product data, with which the type labels are associated, and the non-defective product data. After the second generating step S5, the second determining step S6 involves determining, for each of a plurality of pieces of product data to be determined after the second learning model M2 is generated, whether each product is non-defective or defective and determining the defect type for each defective product using the second learning model M2 instead of the first learning model M1.

The information processing method (which includes the first generating step S1, the first determining step S2, the classifying step S3, the labeling step S4, and the second generating step S5 as described above) facilitates generation of a learning model that makes it possible not only to determine whether each product is non-defective or defective but also to determine the defect type for each defective product as described below. When the number of pieces of product data is small in the first generating step S1, it is not so difficult to extract non-defective product data from the small number of pieces of product data and assign teacher labels (or non-defective product labels) to the extracted non-defective product data. The information processing method would make it possible to determine, in the first determining step S2, whether each product is non-defective or defective in accordance with the first learning model M1 generated from the extracted non-defective product data, if the number of pieces of product data is not small. In the classifying step S3, the product data determined to be defective is grouped according to defect type. Then, a type label is collectively associated with each group in the labeling step S4. Accordingly, the information processing method would facilitate the labeling process even if the number of pieces of product data (or defective product data) is large. In the second generating step S5, the second learning model M2 is generated on the basis of the defective product data to which the type labels are assigned and the non-defective product data. The second learning model M2 thus makes it possible not only to determine whether each product is non-defective or defective but also to determine the defect type for each defective product. Consequently, the information processing method facilitates generation of the learning model (i.e., the second learning model M2) that makes it possible not only to determine whether each product is non-defective or defective but also to determine the defect type for each defective product.

In the second determining step S6, the second learning model M2 is used instead of the first learning model M1. This would make it possible not only to determine whether each product is non-defective or defective but also to determine the defect type for each defective product even if the number of pieces of product data is large.

The information processing method according to the present embodiment thus enables semiautomatic generation of teacher data and learning models (such as the second learning model M2). Because the teacher data and the learning models are easily generated, the information processing method facilitates the start-up of an inspection step (e.g., an automatic inspection step) to be carried out by the information processing apparatus 10. This promotes automation of the inspection step so as to reduce the burden on the operator. Consequently, the information processing method enables a reduction in labor cost and thus contributes to a reduction in manufacturing cost.

In the present embodiment, the product data used in the first generating step S1 is data obtained in the initial stage of the start of information processing. The product data to be determined in the first determining step S2 is data obtained after the initial stage of the start of information processing (e.g., data obtained in the intermediate stage that comes after the initial stage of the start of information processing). The intermediate stage is a stage where a predetermined number of pieces of defective product data are presumably collected. The product data to be determined in the second determining step S6 is data obtained after the intermediate stage that comes after the start of information processing. In the initial stage of the start of information processing where the first generating step S1 is to be performed, the number of pieces of product data is small. Accordingly, it is not so difficult to extract a predetermined number of pieces of product data (or non-defective product data) from the small number of pieces of product data and to assign teacher labels (or non-defective product labels) to the extracted product data (or non-defective product data). If the number of pieces of product data increases in the intermediate stage of information processing, the information processing method would make it possible to determine, in the first determining step S2, whether each product is non-defective or defective in accordance with the already-generated first learning model M1. If the number of pieces of product data increases after the intermediate stage of information processing in the course of actual operation, the second learning model M2 would be used instead of the first learning model M1. This makes it possible not only to determine whether each product is non-defective or defective but also to determine the defect type for each defective product. Thus, when the production of the products continues after the intermediate stage of information processing in the course of actual operation, the information processing method continues the automatic inspection step that involves making determinations using the second learning model M2. Consequently, the information processing method facilitates the start-up of the production line for the products (which includes the inspection step).

The embodiment disclosed herein is not limitative but illustrative in all respects. The scope of the invention is not limited to the foregoing embodiment but embraces all changes and modifications that may fall within the scope of the claims and equivalents thereof. Target products are not limited to steering systems or rolling bearings but may be various other assemblies or mechanical parts. Product data is not limited to vibration data or image data but may be temperature data (or temperature variation data).

The above description is based on the assumption that the type labels indicative of the defect types are associated with the defective product data. In an alternative embodiment, a step label indicating information on a step that has caused occurrence of a defect and precedes the inspection step may be additionally associated with the defective product data. This makes it possible to easily recognize the step that has caused occurrence of a defect when a defective product is determined to be of a certain defect type as a result of an inspection. Consequently, such an alternative embodiment makes it possible to solve trouble in the step so as to minimize production of defective products.

The invention facilitates generation of the learning model (i.e., the second learning model M2) that makes it possible not only to determine whether each product is non-defective or defective but also to determine the defect type for each defective product.

What is claimed is:

1. An information processing method comprising:
a first generating step involving generating a first learning model by conducting machine learning using, as teacher data, at least either a predetermined number of pieces of non-defective product data or a predetermined number of pieces of defective product data extracted from product data;
a first determining step involving determining, for each of a plurality of pieces of product data to be determined after the first learning model is generated, whether each product is non-defective or defective in accordance with the first learning model;
a classifying step involving grouping the pieces of product data determined to be defective in the first determining step, such that these pieces of product data are classified according to defect type;
a labeling step involving collectively associating type labels indicative of defect types with the defective product data according to defect type group provided in the classifying step; and
a second generating step involving generating a second learning model by conducting machine learning using, as teacher data, the defective product data with which the type labels are associated and the non-defective product data.

2. The information processing method according to claim 1, further comprising a second determining step involving determining, for each of a plurality of pieces of product data to be determined after the second learning model is generated, whether each product is non-defective or defective and determining the defect type for each defective product in accordance with the second learning model after the second generating step.

3. The information processing method according to claim 1, wherein
the machine learning conducted in the first generating step is non-defective product learning conducted using the non-defective product data as the teacher data.

4. The information processing method according to claim 2, wherein
the product data used in the first generating step is data obtained in an initial stage of start of information processing,
the product data to be determined in the first determining step is data obtained in an intermediate stage that comes after the initial stage of the start of information processing, and
the product data to be determined in the second determining step is data obtained after the intermediate stage that comes after the start of information processing.

5. The information processing method according to claim 1, wherein
the classifying step involves grouping the product data by conducting a cluster analysis without using any teacher data.

6. An information processing apparatus comprising:
a first generator to generate a first learning model by conducting machine learning using, as teacher data, at least either a predetermined number of pieces of non-defective product data or a predetermined number of pieces of defective product data;
a first determiner to determine, for each of a plurality of pieces of product data, whether each product is non-defective or defective in accordance with the first learning model;
a classifier to group the pieces of product data determined to be defective by the first determiner, such that these pieces of product data are classified according to defect type; and
a second generator to generate a second learning model by conducting machine learning using, as teacher data, the defective product data with which type labels indicative of defect types are associated and the non-defective product data, the type labels being collectively associated with the defective product data according to defect type group provided by the classifier.

7. A program to cause a computer to function as:
a first generator to generate a first learning model by conducting machine learning using, as teacher data, at least either a predetermined number of pieces of non-defective product data or a predetermined number of pieces of defective product data;
a first determiner to determine, for each of a plurality of pieces of product data, whether each product is non-defective or defective in accordance with the first learning model;
a classifier to group the pieces of product data determined to be defective by the first determiner, such that these pieces of product data are classified according to defect type; and
a second generator to generate a second learning model by conducting machine learning using, as teacher data, the defective product data with which type labels indicative of defect types are associated and the non-defective product data, the type labels being collectively associated with the defective product data according to defect type group provided by the classifier.
